(19) United States
(12) Patent Application Publication
(10) Pub. No.: US 2020/0208753 A1
(43) Pub. Date: Jul. 2, 2020

(54) TUBULAR ARMATURE FOR A SOLENOID VALVE

(71) Applicant: Walbro LLC, Tucson, AZ (US)

(72) Inventor: Jeffrey C. Hoppe, Cass City, MI (US)

(21) Appl. No.: 16/613,647

(22) PCT Filed: May 17, 2018
(86) PCT No.: PCT/US2018/033067

§ 371 Date: Nov. 14, 2019

Related U.S. Application Data
(60) Provisional application No. 62/507,479, filed on May 17, 2017.

(51) Int. Cl. F16K 31/06

(52) U.S. Cl. CPC F16K 31/0658; F16K 31/0675

(57) ABSTRACT

In at least some implementations, an armature for a solenoid valve includes a tubular main body and a head. The main body has an axis, a first end and a second end spaced axially from the first end. An outer surface of the main body is spaced radially from the axis and extends between the first end and the second end, and an inner surface is spaced radially inwardly from the outer surface and defines a cavity within the main body. The head is formed from a different material than the main body and carried by the main body, the head enclosing at least part of the cavity in the main body. The armature may be used in a solenoid valve and may be driven by an electromagnetic field generated by a coil of the solenoid.

### REFERENCE TO RELATED APPLICATIONS

This application claims the benefit of U.S. Provisional Application Ser. No. 62/507,479 filed on May 17, 2017, the entire contents of which are incorporated herein by reference in their entireties.

### TECHNICAL FIELD

The present disclosure relates generally to an armature for a solenoid valve.

### BACKGROUND

Solenoid valves are used in a wide range of devices to control fluid flow. Such valves utilize an armature driven by a magnetic field selectively generated by selectively providing electric current to a coil. Some solenoids are used with engine fuel system components, such as on or in a carburetor for an engine system that does not include a battery. In at least these implementations, it is desirable to reduce the current needed to drive the solenoid as the electrical energy available in such systems may be limited. Further, there is a need to accurately manufacture certain components at a low cost, like the armature which is a solid piece of metal and may be forged and/or machined to its final form which adds to the cost and complexity of the manufacturing process.

### SUMMARY

In at least some implementations, an armature for a solenoid valve includes a tubular main body and a head. The main body has an axis, a first end and a second end spaced axially from the first end. An outer surface of the main body is spaced radially from the axis and extends between the first end and the second end, and an inner surface is spaced radially inwardly from the outer surface and defines a cavity within the main body. The head is formed from a different material than the main body and carried by the main body, the head enclosing at least part of the cavity in the main body.

In at least some implementations, the head is formed from a polymeric material and is bonded to the main body, such as by being directly bonded to the material of the main body, and/or an adhesive may be used to at least partially bond the head to the main body. The head may close the first end of the main body so that the cavity is closed at one end.

In at least some implementations, one or both of the outer surface and the inner surface is/are continuous and at a constant radial distance from the axis. The main body may have a constant thickness along the axial length of the main body. A surface area of the main body taken in a plane perpendicular to the axis may be between 20% and 95% of the surface area bounded by the outer surface. And one or both of the first end and the second end may be arranged perpendicular to the axis or at an angle of less than 20 degrees of perpendicular to the axis.

In at least some implementations, a solenoid valve includes a housing, a bobbin received at least partially within the housing and having a body about which a coil is provided, a fluid flow path including an inlet and an outlet and a valve seat defined by at least one of the housing or the bobbin, and an armature moveable relative to the valve seat to control flow through the fluid flow path. The armature has a tubular main body with an axis, a first end and a second end spaced axially from the first end. An outer surface is spaced radially from the axis and extends between the first end and the second end, and an inner surface is spaced radially inwardly from the outer surface and defines a cavity within the main body. A head is carried by the main body and encloses at least part of the cavity in the main body.

In at least some implementations, the head is formed from a different material than the main body, and/or one or both of the outer surface and inner surface is/are continuous and at a constant radial distance from the axis. A surface area of the main body taken in a plane perpendicular to the axis may be between 20% and 95% of the surface area bounded by the outer surface.

In at least some implementations, a method of forming an armature for a solenoid, comprises the steps of providing a tube of a desired length, inserting the tube into a die, and molding a head onto the tube where the head is formed from a polymeric or composite material. The tube may be formed by one or more of by extrusion, molding, casting or roll-forming. The step of providing the tube of the desired length may be accomplished by shortening a tube that is longer than the desired length.

### BRIEF DESCRIPTION OF THE DRAWINGS

The following detailed description of certain embodiments and best mode will be set forth with reference to the accompanying drawings, in which:

FIG. 1 is a perspective view of a carburetor including a solenoid valve as described;

FIG. 2 is a sectional view through the solenoid valve;

FIG. 3 is a diagrammatic view of an armature stop, spring and armature;

FIG. 4 is a diagrammatic view of an armature stop, spring and armature; and

FIG. 5 is a sectional view of a die and tube used to form an armature.

### DETAILED DESCRIPTION

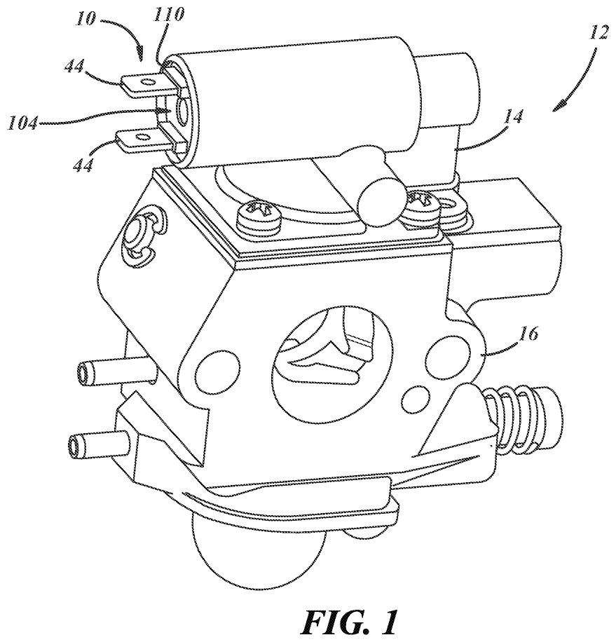

Referring in more detail to the drawings, FIG. 1 illustrates a solenoid valve 10 carried by a carburetor 12 to control the flow of a fluid (e.g. gaseous, like air or liquid, like fuel) within one or more passages in the carburetor. The solenoid valve 10 may be received within a cover 14 connected to a main body 16 of the carburetor 12, or otherwise carried by or associated with the carburetor. While shown in use with a diaphragm carburetor, the solenoid valve 10 may be used with any type of carburetor, throttle body or with other devices.

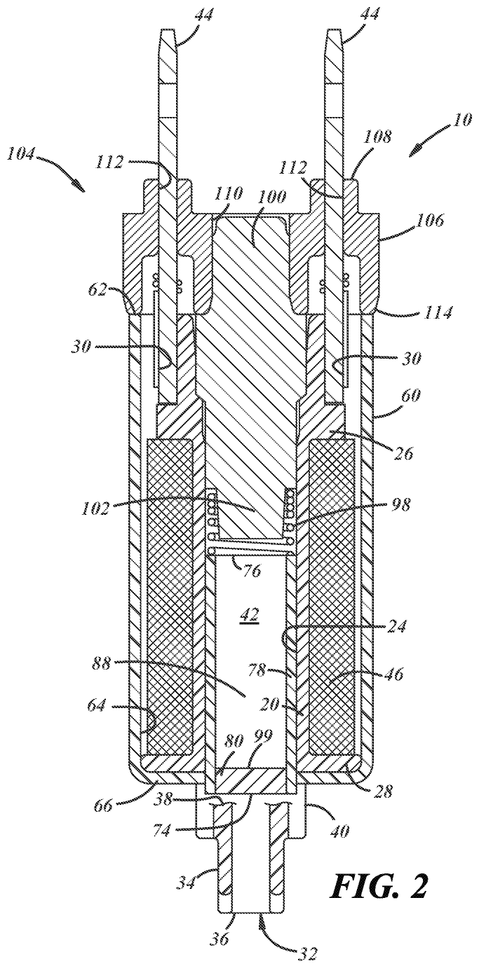

Referring to FIG. 2, the solenoid valve 10 includes a bobbin 20 with a body including an internal passage 24, and spaced apart and radially outwardly extending flanges 26, 28. Terminal cavities 30 may be provided extending generally axially from an upper one of the flanges 26, and a fluid flow path or passage 32 may be provided at the opposite flange 28. The fluid passage 32 may extend into and be defined at least in part by a cylindrical boss 34 carried by the body. The boss 34 is open at one end defining an inlet 36 of the passage 32 and an internal valve seat 38 is defined at its other end. Downstream of the valve seat 38, one or more fluid outlets 40 are provided in the body. The valve seat 38 faces the internal passage 24, and an armature 42 received in the passage 24 may open and close, or control the opening and closing of, the valve seat 38 as the armature 42 is driven by the solenoid. In the illustrated embodiment, four outlets 40 are provided. While not required, the bobbin 20 and all of the features described above including the valve seat 38, body, terminal cavities 30 and fluid flow passages/ports may all be integrally provided in the same component and may be formed in the same piece of material. In at least one implementation, the bobbin is molded from a plastic material and includes all of these features in a single, as-molded body.

Electric terminals 44 are provided in the terminal cavities 30. The terminals 44 are formed from metal, are connected to a wire of the solenoid coil 46, and define part of the electrical circuit of the solenoid valve 10. The terminals 44 may be generally thin strips of metal that are pressed into the terminal cavities 30.

In one form, the wire coil 46 is provided by tying one end of a wire to one of the terminals 44, winding the wire 46 a desired number of times around the bobbin body between the flanges 26, 28, and then tying off the other end of the wire 46 to the other of the terminals 44. After the wire 46 is provided on the bobbin 20, the bobbin may be inserted into a housing 60. The housing 60 may be generally cylindrical and open at an upper end 62 that is received adjacent to the terminals 44. To reduce vibrations and/or help retain the bobbin 20 within the housing 60, the bobbin flanges 26, 28 may be relatively closely received within an interior surface 64 of the housing 60, if desired. The lower end of the housing may include and inwardly extending wall 66. The housing 60 may be formed from metal and may define part of the magnetic flux path of the solenoid valve as will be described.

Next, the armature 42 may be inserted into the bobbin internal passage 24 with one end 74 adjacent to the valve seat 38 and the opposite end 76 within the bobbin body and surrounded by the solenoid coil 46. The armature 42 may be formed of a ferromagnetic material and is slidably received within the internal passage 24 so that it may move relative to the valve seat 38 as will be described.

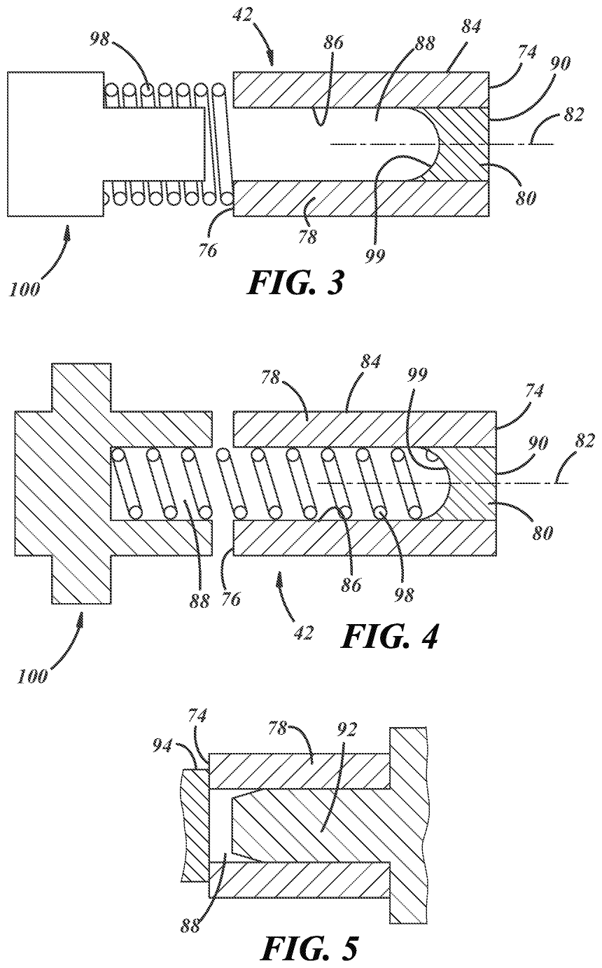

As shown in FIGS. 3 and 4, the armature 42 may include a main body 78 and a head 80. The main body 78 may be tubular, and in at least some implementations, may be circular in cross-section and define a hollow, right circular cylinder. The main body 78 may have a central axis 82, an outer surface 84 along an axial length of the main body between the first end 74 and the axially opposite second end 76, where the outer surface 84 is arranged adjacent to the bobbin wall(s) that define the internal passage 24. The main body 78 may have an inner surface 86 radially spaced from the outer surface 84 and defining an internal void 88 in the main body 78. A thickness of the main body 78 is defined between the inner and outer surfaces 84, 86 and the main body may have a uniform or constant thickness along its axial length. One or both of the first end 74 and the second end 76 may be arranged generally perpendicular to the axis 82, where the term generally perpendicular includes angles of between 0 (zero) degrees and 20 degrees of perpendicular (where an end oriented at 0 degrees is perpendicular to the axis). In at least some implementations, the armature 42 may conveniently be formed from a straight, tubular piece of material, which may be formed by extrusion, molding, casting or roll-forming. In at least some implementations, the main body 78 is formed from a ferromagnetic material and may be formed from a metal such as, but not limited to, FR430, ASK3200, ERGSTE 1.4105IL or any other solenoid grade steel.

That is, in at least some implementations, both the outer surface 84 and inner surface 86 may be of constant radial dimension along their axial lengths, and may define right circular cylinders along their axial lengths. The inner and outer surfaces 84, 86 may be solid and continuous, without voids, apertures, radially extending shoulders or other discontinuity along their axial lengths, providing a very simple and easy to manufacture main body 78. With the simple main body 78 construction, tolerances within a production run of components can be tightly controlled (e.g. of the outer diameter) as compared to armatures having more complex body shapes, including grooves in their outer surfaces (e.g. for a seal or o-ring or a bearing), inwardly extending shoulders or other features to provide a seat for a spring, valve head or the like. Further, the axial length of the main body 78 can be easily controlled by simple processes including cutting from a length of tubular stock and then sanding, grinding or otherwise removing material from an end (74 or 76) of the main body until a desired length is achieved. A surface area of the annular main body 78, taken in a plane perpendicular to the axis, may be between about 20% and 95% of the surface area bounded by the outer surface 84. Thus, the cavity 88 may have a surface area in that plane of between 5 and 80% of the surface area bounded by the outer surface 84.

The head 80 may be carried by the main body 78 at or adjacent to the first end 74. The head 80 may be formed from a different material than the main body 78 and may be attached to the main body in any suitable way, such as by bonding, heat staking, welding, adhesive, and/or by being overmolded to the main body. In at least some implementations, the head 80 is formed from a polymeric material such as, but not limited to, Nitrile or FKM, or a composite material such as, but not limited to, fiber-reinforced polymers, metal or carbon reinforced or doped polymers, etc. The head 80 could be ferromagnetic (e.g. a polymer carrying, doped with or otherwise including ferromagnetic particles) to assist in the magnetic response of the armature, but need not be ferromagnetic. The head 80 may partially or fully enclose the first end 74 of the main body 78, and in at least some implementations, the head 80 is arranged to engage the valve seat 38 to define a closed position of the solenoid valve 10 in which fluid is prevented or inhibited from flowing through the valve seat 38. The cavity 88 in the armature may thus be closed at one end, and if desired, the other end may be open to simplify the construction of the main body 78 and the armature 42 generally. An outer or end surface 90 of the head 80 that faces the valve seat 38 in assembly, may be flush with the first end 74 of the main body 78, may cover the first end 74 or extend beyond the first end 74, or the outer surface 90 may be recessed from the first end 74 and the valve seat 38 may be defined by a projection or boss that has a diameter less than the inner diameter of the main body 78 and in the closed position of the valve 10, the projection may extend at least partially into the main body 78 to engage the outer surface 90 of the head 80. The head 80 including its outer surface 90 may have any desired shape. The armature 42 described herein may be used with solenoids different than that described herein—the solenoid as described is merely one example of a solenoid in which the armature may be used.

One way to form the armature 42 is to form the tubular main body 78 as desired and then place the main body within a die. As generally shown in FIG. 5, the die may include a post 92 having an outer diameter close to the inner diameter of the main body 78, and the main body may be received on the post. The die or another tool 94 may close the end 74 of the main body. Next, the material of the head may be injected or otherwise provided into the cavity 88, between the end of the post 92 and the tool 94 to overmold the head 80 to the main body 78. In at least some implementations, the heat provided during the molding process may be sufficient to cause the material of the head 80 to bond to the main body 78 without the need for an adhesive or other connector. In other implementations, an adhesive may be used, or additional processes such as heat staking or welding may be performed to couple the head 80 to the main body 78 so that the head is carried by and moves with the main body. The head 80 could instead be formed separate from the main body 78 and coupled thereto after the head is formed and cured or hardened. The head 80 could be press-fit or otherwise coupled to the main body 78 with an interference fit, and/or adhered, staked or welded to the main body, as desired.

A biasing member, such as a spring 98 may be received within the internal passage 24 and have one end engaged with the armature 42. The spring 98 may engage the second end 76 of the main body 78, as shown in FIGS. 2 and 3, or the spring 98 may engage an inner surface 99 of the head 80, as shown in FIG. 4. The spring 98 biases the armature 42 into engagement with the valve seat 38 so that the valve 10 is normally closed. That is, unless the armature 42 is moved away from the valve seat 38 by a magnetic force generated by the solenoid, the spring 98 urges the armature 42 into the valve seat 38 to inhibit or prevent fluid flow through the valve seat 38.

As shown in FIG. 2, an armature stop 100 is provided in the open end of the bobbin 20 to close the open end, provide a reaction surface for the spring 98 and a stop surface that may be engaged by the armature 42 to limit its travel. The armature stop 100 may include a spring retention feature, such as a reduced diameter nose 102 at one end, or the spring 98 may simply engage an end of the armature stop 100.

The solenoid 10 may include a cap 104 that may have a generally cylindrical sidewall 106 leading to an upper wall 108. The upper wall 108 may include an opening 110 that receives part of the armature stop 100, and a pair of slots 112 through which the terminals 44 extend when the cap 104 is inserted onto the terminals 44 and pressed into its assembled position. If desired, as the cap 104 is installed to its final position, the cap 98 may engage the armature stop 100 and drive the armature stop to its final, assembled position. In this position, the armature stop 100 is engaged with the bobbin 20 within its internal passage 24 and trapped between the bobbin 20 and cap 104. This movement of the armature stop 100 may compress the spring 98 between the armature stop 100 and armature 42 to provide a desired spring force acting on the armature. A lower edge 114 of the cap sidewall 106 may be pressed flush against the open end of the housing 60 to provide a positive stop for the cap 104 that may be visually verified. Of course, the cap sidewall 106 could be received over or within the housing 60, if desired. The cap 104 may provide a dust/contaminant shield for the soldered wire-to-terminal connection, and the solenoids internal components generally. The cap 104 may provide support for the terminals 44 so that they are less likely to be unduly flexed and or displaced from their cavities 30. And the cap 104 may help retain the solenoid valve 10 within a cavity 110 in which the solenoid valve 10 is received, for example, as shown in FIG. 1.

In use, when electricity is supplied to the terminals 44, the wire coil 46 generates a magnetic field that displaces the armature 42 against the spring 98 and into engagement with the armature stop 100. This moves the armature away from the valve seat 38 and permits fluid flow through the inlet 36 and toward the outlet(s) 40. When electricity is not supplied to the terminals 44, the armature 42 is returned to its closed position by the spring 98 and fluid flow through the valve seat 38 is inhibited or prevented by engagement of the armature 42 with the valve seat 38. Of course, the inlet and outlet and the fluid flow can be reversed in some applications.

The forms of the invention herein disclosed constitute presently preferred embodiments and many other forms and embodiments are possible. It is not intended herein to mention all the possible equivalent forms or ramifications of the invention. It is understood that the terms used herein are merely descriptive, rather than limiting, and that various changes may be made without departing from the spirit or scope of the invention.

What is claimed is:

1. An armature for a solenoid valve, comprising:
a tubular main body having an axis, a first end and a second end spaced axially from the first end, an outer surface spaced radially from the axis and extending between the first end and the second end, and an inner surface spaced radially inwardly from the outer surface and defining a cavity within the main body; and
a head formed from a different material than the main body and carried by the main body, the head enclosing at least part of the cavity in the main body.

2. The armature of claim 1 wherein the head is formed from a polymeric material and is bonded to the main body.

3. The armature of claim 2 wherein the material of the head is directly bonded to the material of the main body.

4. The armature of claim 2 wherein an adhesive at least partially bonds the head to the main body.

5. The armature of claim 1 wherein the outer surface is continuous and at a constant radial distance from the axis.

6. The armature of claim 1 wherein the inner surface is continuous and at a constant radial distance from the axis.

7. The armature of claim 1 wherein the outer surface is continuous and at a constant radial distance from the axis, and the inner surface is continuous and at a constant radial distance from the axis so that the main body has a constant thickness along the axial length of the main body.

8. The armature of claim 1 wherein the head closes the first end of the main body so that the cavity is closed at one end.

9. The armature of claim 1 wherein a surface area of the main body taken in a plane perpendicular to the axis may be between 20% and 95% of the surface area bounded by the outer surface.

10. The armature of claim 1 wherein one or both of the first end and the second end may be arranged perpendicular to the axis or at an angle of less than 20 degrees of perpendicular to the axis.

11. A solenoid valve, comprising:
a housing;
a bobbin received at least partially within the housing and having a body about which a coil is provided;
a fluid flow path including an inlet and an outlet and a valve seat defined by at least one of the housing or the bobbin; and
an armature moveable relative to the valve seat to control flow through the fluid flow path, the armature having a tubular main body with an axis, a first end and a second end spaced axially from the first end, an outer surface spaced radially from the axis and extending between the first end and the second end, and an inner surface spaced radially inwardly from the outer surface and defining a cavity within the main body, and a head carried by the main body and enclosing at least part of the cavity in the main body.

12. The solenoid of claim 11 wherein the head is formed from a different material than the main body.

13. The solenoid of claim 11 wherein the outer surface is continuous and at a constant radial distance from the axis.

14. The armature of claim 11 wherein the inner surface is continuous and at a constant radial distance from the axis.

15. The armature of claim 11 wherein a surface area of the main body taken in a plane perpendicular to the axis may be between 20% and 95% of the surface area bounded by the outer surface.

16. A method of forming an armature for a solenoid, comprising the steps of:
providing a tube of a desired length;
inserting the tube into a die; and
molding a head onto the tube where the head is formed from a polymeric or composite material.

17. The method of claim 17 wherein the tube is formed by one or more of by extrusion, molding, casting or roll-forming.

18. The method of claim 16 wherein the step of providing the tube of the desired length is accomplished by shortening a tube that is longer than the desired length.
